(19) United States
(12) Patent Application Publication
(10) Pub. No.: US 2020/0114951 A1
(43) Pub. Date: Apr. 16, 2020

(54) MOTOR TORQUE CONTROL DEVICE OF VEHICLE STEERING SYSTEM

(71) Applicants: HYUNDAI MOTOR COMPANY, Seoul (KR); KIA MOTORS CORPORATION, Seoul (KR)

(72) Inventor: Chan Jung KIM, Hwaseong-si (KR)

(73) Assignees: HYUNDAI MOTOR COMPANY, Seoul (KR); KIA MOTORS CORPORATION, Seoul (KR)

(21) Appl. No.: 16/395,519

(22) Filed: Apr. 26, 2019

(30) Foreign Application Priority Data
Oct. 16, 2018 (KR) 10-2018-0122981

(51) Int. Cl. B62D 5/04

(52) U.S. Cl. CPC B62D 5/0463; B62D 5/0481

(57) ABSTRACT

A motor torque control device of a vehicle steering system includes: an imaginary steering torque determination unit to estimate an imaginary steering torque which is input to a steering gear of a vehicle when a steering wheel of the vehicle is rotated at a maximum steering angle; a subtraction torque determination unit to calculate a difference between the imaginary steering torque and an actual steering torque; a compensation torque determination unit to determine a compensation torque for compensating the actual steering torque based on the difference and a vehicle speed of the vehicle; and a motor torque determination unit to determine an output torque of an electromotor based on the compensation torque and a motor assist torque of the electromotor.

### CROSS-REFERENCE TO RELATED APPLICATION

This application claims priority to and the benefit of Korean Patent Application No. 10-2018-0122981, filed on Oct. 16, 2018, the entire contents of which are incorporated herein by reference.

### FIELD

The present disclosure relates to a motor torque control device of a vehicle steering system to enhance the turning performance of a vehicle.

### BACKGROUND

The statements in this section merely provide background information related to the present disclosure and may not constitute prior art.

In general, during vehicle turning, a vehicle is subjected to centrifugal force toward an outside of the turning direction and is subjected to lateral force toward an inside of the turning direction. In this case, when the lateral force and the centrifugal force that are applied to a tire of a vehicle wheel are balanced, the vehicle is capable of stably turning without slipping.

As a steering angle increases when a driver rotates a steering wheel of a vehicle, a slip region of a ground contact surface of a tire gradually increases. Such an increase in a slip region is accompanied by increased driver concern about vehicle spin due to tire slippage. In other words, the driver is concerned about the possibility of vehicle spin during rotation of the steering wheel and, thus, reduces a steering torque even before tire grip performance with respect to a road surface reaches a limit.

As such, when the driver reduces the steering torque even before the tire grip performance reaches the limit, the vehicle turns in a turning direction in a state in which the steering wheel is not rotated at a maximum steering angle. In this regard, when the steering angle of the steering wheel reaches a maximum steering angle (limit), the lateral force of a tire is capable of being used to a maximum degree.

We have discovered that when the driver steering torque and steering angle are reduced even before the steering angle of the steering wheel reaches the maximum steering angle, the lateral force applied to a tire during vehicle driving is not capable of being used to a maximum degree, and thus there is a problem in that the turning performance of a vehicle is degraded and the steering sense of a driver is degraded during manipulation of a steering wheel.

### SUMMARY

In one aspect, the present disclosure provides a motor torque control device of a vehicle steering system, which estimates and calculates an imaginary steering torque input to a steering gear during rotation of the steering wheel at a maximum steering angle and an actual steering torque input to the steering gear depending on a real-time steering angle of the steering wheel, generates a motor assist torque, and additionally compensates an actual steering torque based on a difference value between the imaginary steering torque and the actual steering torque when compensating a driver steering torque, thereby enhancing the turning performance of a vehicle.

In one form, a motor torque control device of a vehicle steering system, for generating a motor assist torque for assisting a driver steering torque input to a steering gear using an electromotor may include: an imaginary steering torque determination unit for estimating an imaginary steering torque which is input to the steering gear of the vehicle when a steering wheel of the vehicle is rotated at a maximum steering angle, a subtraction torque determination unit for calculating a difference between the imaginary steering torque and an actual steering torque which is determined based on a real-time steering angle of the steering wheel, a compensation torque determination unit for determining a compensation torque for compensating the actual steering torque based on the difference and a vehicle speed of the vehicle, and a motor torque determination unit for determining an output torque of the electromotor based on the compensation torque and the motor assist torque for assisting the driver steering torque.

In another form, the imaginary steering torque determination unit may estimate the imaginary steering torque based on lateral force of a tire of a vehicle wheel of the vehicle and an imaginary pneumatic trail, where the imaginary pneumatic trail is a pneumatic trail value at which tire slippage of the vehicle does not occur. In detail, the imaginary steering torque may be calculated using “Lateral force of tire×(Caster trail+Imaginary pneumatic trail)/Moment arm×Steering gear ratio+Friction torque”. The caster trail may be a distance between an intersection point of a vertical line passing through the center of a wheel hub of a vehicle wheel at a road surface and an intersection point of a downward extension line of a central line of a kingpin at the road surface and the moment arm may be a distance between a kingpin and a tie road. The kingpin may be installed at an end of an axle as a rotation axis of a knuckle for changing the driving direction of a front wheel and the tie rod may be installed between a steering gear and a front wheel. The steering gear ratio may be a gear ratio between a pinion and a rack bar of the steering gear, and the friction torque may be a friction torque generated in the steering system. In addition, the imaginary steering torque determination unit may predict the lateral force of the tire based on lateral acceleration and a yaw rate of a vehicle, real-time vehicle speed, a vehicle weight, a distance to the vehicle wheel from a vehicle center, and a mass moment of inertia.

In still another form, the subtraction torque determination unit may calculate a subtraction torque by subtracting the actual steering torque from the imaginary steering torque, and may calculate the actual steering torque by summing the motor assist torque and the driver steering torque generated in real time.

In yet another form, the compensation torque determination unit may determine a gain of the subtraction torque based on the vehicle speed and determines the compensation torque using the gain. When the vehicle speed is less than a predetermined first vehicle speed, the gain may be determined as ‘0’, when the vehicle speed is equal to or greater than a second vehicle speed that is greater than the first vehicle speed, the gain may be determined as a predetermined maximum gain value, and when the vehicle speed is equal to or greater than the first vehicle speed and less than the second vehicle speed, the gain may be determined as a value between ‘0’ and the maximum gain in proportion to the vehicle speed. In addition, the compensation torque may be calculated using “Subtraction torque×Gain”.

In still yet another form, the motor torque determination unit may calculate the output torque of the electromotor by subtracting the compensation torque from the motor assist torque.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram showing the configuration of a motor torque control device of a vehicle steering system in one form of the present disclosure;

FIG. 2 is a diagram showing a model of an electric power steering system;

FIG. 3 is a diagram showing an example of the configuration of a subtraction torque determination unit included in a motor torque control device;

FIG. 4 is a diagram showing the concept of a method of calculating a subtraction torque of a subtraction torque determination unit; and

FIG. 5 is a diagram showing the concept of a method of determining a gain of a compensation torque determination unit included in a motor torque control device.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

First, the reason why a driver reduces the steering torque (the operating force of a steering wheel) even before a steering angle of a steering wheel has reached a limit (maximum steering angle) during vehicle turning will be described below.

When a slip angle of a tire of a vehicle wheel exceeds a threshold value during vehicle driving, a ground contact surface of the tire may be divided into a cohesive region that grips a road surface and a slip region that does not grip the road surface and thus slides on the road surface. When the steering angle of the steering wheel increases, a slip angle of the tire may increase, and as the slip angle exceeds the threshold value and increases, the slip region of the ground contact surface of the tire may increase, and as the slip region increases, a pneumatic trail may be reduced.

The pneumatic trail is the distance between a central point of the ground contact surface of a tire of the vehicle wheel and a point of application (or a point of application of turning force) of lateral force applied to the tire of the vehicle wheel, and the restoring moment of the tire, which is generated along with deformation of the tire during vehicle turning, may be determined using the equation “restoring moment=lateral force×pneumatic trail”. Accordingly, as the pneumatic trail is reduced, the restoring moment of the tire may be reduced.

When the restoring moment is reduced, a driver may feel as if tire grip performance is degraded due to the force transmitted through a steering wheel. The restoring moment may be gradually reduced until the tire grip performance reaches a limit and the tire slips on the road surface. Accordingly, the driver worries about vehicle spin due to tire slippage even before the tire grip performance reaches a limit, that is, even before the steering wheel reaches a limit (maximum steering angle). In other words, the driver is nervous due to the possibility of vehicle spin during rotation of the steering wheel. Accordingly, the driver reduces steering torque even before tire grip performance with respect to a road surface reaching a limit.

As such, when the driver reduces the steering torque even before the tire grip performance reaches the limit, the vehicle turns in a turning direction in a state in which the steering wheel is not rotated at a maximum steering angle. In this regard, when the steering angle of the steering wheel reaches a maximum steering angle, lateral force of a tire is capable of being used to a maximum degree.

Accordingly, when the driver steering torque and steering angle are reduced even before the steering angle of the steering wheel reaches the maximum steering angle, the lateral force applied to a tire during vehicle driving is not capable of being used to a maximum degree, and thus the turning performance of a vehicle is degraded and the steering sense of a driver is degraded during the manipulation of a steering wheel.

Accordingly, the present disclosure may estimate and calculate the imaginary steering torque input to a steering gear during the rotation of the steering wheel at a maximum steering angle and the actual steering torque input to the steering gear depending on the real-time steering angle of the steering wheel, may generate a motor assist torque, and may additionally compensate the actual steering torque based on the difference between the imaginary steering torque and the actual steering torque when compensating the driver steering torque, thereby enhancing the turning performance of a vehicle.

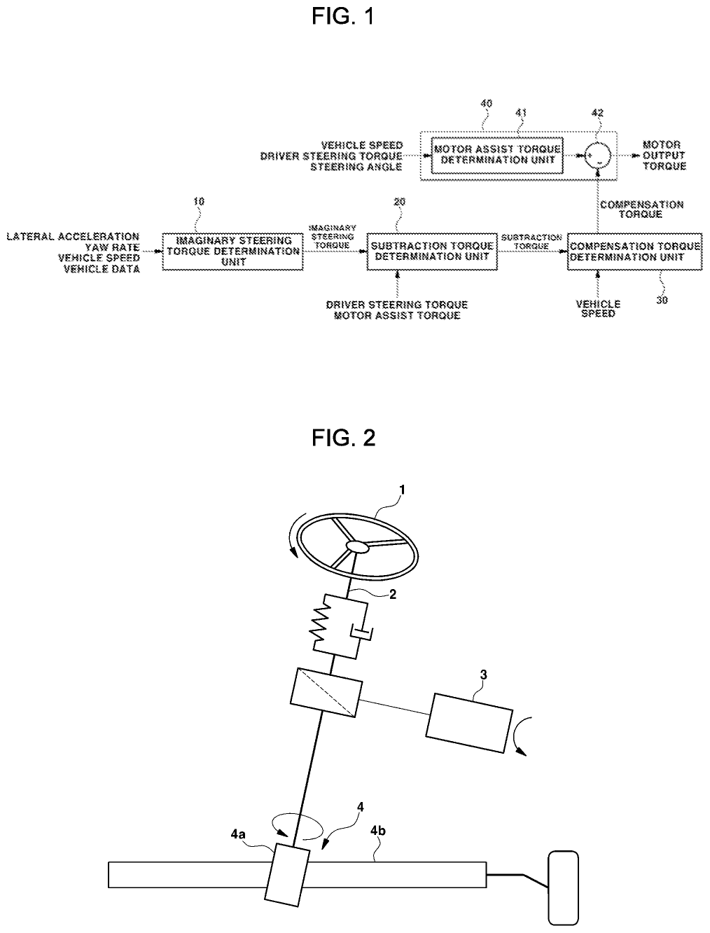

Hereinafter, the present disclosure will be described so that it may be easily implemented by those of ordinary skill in the art with reference to FIGS. 1 to 5.

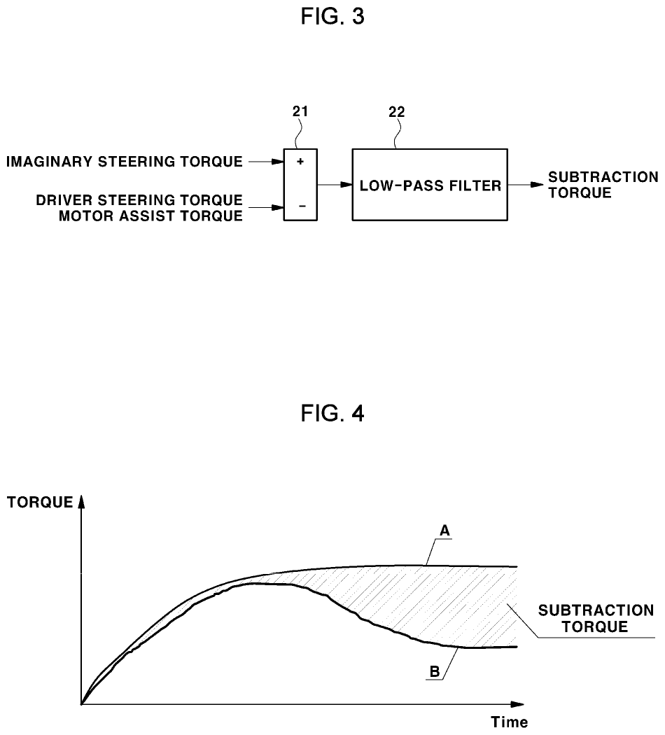

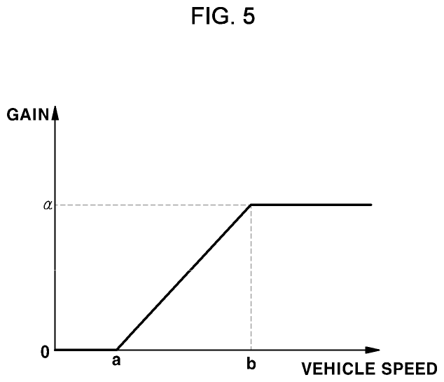

FIG. 1 is a schematic diagram showing the configuration of a motor torque control device of a vehicle steering system in one form of the present disclosure. FIG. 2 is a diagram showing a model of an electric power steering system. FIG. 3 is a diagram showing an example of the configuration of a subtraction torque determination unit included in the motor torque control device. FIG. 4 is a diagram showing the concept of a method of calculating the subtraction torque of the subtraction torque determination unit. FIG. 5 is a diagram showing the concept of a method of determining a gain of a compensation torque determination unit included in the motor torque control device.

As shown in FIG. 1, the motor torque control device of the vehicle steering system may include an imaginary steering torque determination unit 10, a subtraction torque determination unit 20, a compensation torque determination unit 30, and a motor torque determination unit 40 and, in this case, the determination units 10, 20, 30, and 40 may be included in a controller of a vehicular electric power steering system.

Referring to FIG. 2, the electric power steering system may generally use an electromotor 3 to generate an assist torque for assisting driver steering wheel operating force (driver steering torque) using an electromotor 3 and the assist torque (motor assist torque) of the electromotor 3 may be determined and controlled depending on the driver steering torque, the real-time vehicle speed, and the steering angle of a steering wheel 1. The driver steering torque and the motor assist torque may be input to a pinion 4a included in a steering gear 4 through a steering shaft 2 that functions as a rotation axis of the steering wheel and may be transmitted to a vehicle wheel through a rack bar 4b of the steering gear 4, which is engaged with the pinion 4a with a predetermined gear ratio.

The imaginary steering torque determination unit 10 may estimate and determine imaginary steering torque which is input to the steering gear 4 through the steering shaft 2 that is connected to the steering wheel 1 and the electromotor 3 during vehicle turning. The imaginary steering torque may be determined as a steering torque value that is input to the steering gear 4 through the steering shaft 2 when a steering angle of the steering wheel 1 reaches a limit (i.e., a maximum steering angle) immediately before tire slippage occurs. In other words, the imaginary steering torque determination unit 10 may calculate the imaginary steering torque assuming that the steering angle of the steering wheel 1 reaches a limit (i.e., a maximum steering angle) immediately before tire slippage occurs. That is, the imaginary steering torque determination unit 10 may set the pneumatic trail to a predetermined value (i.e., an imaginary pneumatic trail) and may calculate an imaginary steering torque assuming that a pneumatic trail of a tire is not changed. The imaginary pneumatic trail may be set to a pneumatic trail value at which tire slippage does not occur, and may be changed depending on vehicles. The imaginary steering torque may be calculated using Equation 1 below.

Imaginary steering torque=Lateral force of tire×(Caster trail+Imaginary pneumatic trail)/Moment arm×Steering gear ratio+Friction torque Equation 1:

The lateral force is applied to a tire of a vehicle wheel in a lateral direction during vehicle turning, is generated as rubber reaction force for restoring deformation of tire tread, which occurs during vehicle turning, and is exerted in the direction in which the slip angle of the tire is reduced. The caster trail is the distance between an intersection point of a vertical line passing through the center of a wheel hub of a vehicle wheel at a road surface and an intersection point of a downward extension line of a central line of a kingpin at the road surface, the imaginary pneumatic trail is a distance between a central point of a ground contact surface of a tire and a point of application of lateral force of the tire, and the moment arm is the shortest distance between a kingpin and a tie rod.

The kingpin is installed at an end of an axle as a rotation axis of a knuckle for changing the driving direction of a front wheel and the tie rod is installed between a steering gear and a front wheel. The steering gear ratio is a gear ratio between the pinion 4a and the rack bar 4b that constitute the steering gear 4, and the friction torque is a mechanical friction torque that is generated in a steering system during vehicle turning. The imaginary pneumatic trail may be set to a value that is selected from a pneumatic trail value at which tire slippage does not occur, or may be set as a value that is selected via a preliminary test, evaluation, or the like. Each of the caster trail, the moment arm, and the friction torque may be a predetermined value that is set depending on the vehicle.

The lateral force of the tire may be determined based on a lateral acceleration and the yaw rate of a vehicle, a real-time vehicle speed, and vehicle data, and the lateral force of the tire may be determined by a lateral force determination map that is configured to determine the lateral force based on the lateral acceleration, the yaw rate, the vehicle speed, and the vehicle data. The lateral force determination map may be pre-established via a test, evaluation, or the like, and may be stored in the imaginary steering torque determination unit 10. The lateral force determination map may be configured to determine the lateral force using a vehicle weight, a distance to a vehicle wheel (a front wheel or a rear wheel) from the vehicle center, and a mass moment of inertia of the vehicle data, as an input value. The yaw rate is also referred to as yaw angular velocity, and refers to velocity at which a rotation angle (yaw angle) around a vertical line passing through the center of a vehicle is changed. Information on vehicle data, such as the vehicle weight, the distance to the vehicle wheel from the vehicle center, and the mass moment of inertia may be values that are determined differently for different vehicles, and may be input and stored in the imaginary steering torque determination unit 10.

As such, an imaginary steering torque predicted by the imaginary steering torque determination unit 10 may be predicted using a pneumatic trail (i.e., an imaginary pneumatic trail) of a fixed value irrespective of a change in an actual pneumatic trail during vehicle turning and may also be estimated by a steering torque value that is not affected by a change in restoring moment.

The subtraction torque determination unit 20 may be configured to predict and calculate a difference (i.e., subtraction torque) between the imaginary steering torque and the actual steering torque input to the steering gear 4 through the steering shaft 2 in real time during vehicle driving.

As shown in FIG. 3, the subtraction torque determination unit 20 may include a subtraction torque calculation unit 21 for determining the subtraction torque based on the imaginary steering torque and the actual steering torque, and a low-pass filter 22 for removing a noise component (e.g., irregular external force generated from a road surface) contained in the subtraction torque calculated by the subtraction torque calculation unit 21.

The subtraction torque calculation unit 21 may subtract the actual steering torque from the imaginary steering torque to calculate a subtraction torque, and the actual steering torque may be generated depending on a real-time steering angle (driver steering angle) of the steering wheel 1 rotated by the driver. That is, the actual steering torque may be determined based on the real-time steering angle. In other words, the actual steering torque may be determined as a value obtained by summing a driver steering torque generated depending on the real-time steering angle and a motor assist torque for assisting the driver steering torque. Accordingly, the subtraction torque calculation unit 21 may calculate the subtraction torque based on the imaginary steering torque, the driver steering torque, and the motor assist torque. From the subtraction torque calculated by the subtraction torque calculation unit 21, a noise component may be removed by the low-pass filter 22.

When a driver increases a steering angle of a steering wheel for vehicle turning, the driver may interpret a reduction in a restoring moment of a tire and lightening of a steering sense of the steering wheel as a limitation of tire grip performance and may reduce a steering torque for rotation of the steering wheel. To increase the turning performance of a vehicle, the driver needs to generate a steering torque to a maximum torque (steering torque immediately before tire slippage occurs), and may then maintain the maximum torque (refer to plot A of an imaginary steering torque of FIG. 4). However, when the driver feels a reduction in the restoring moment of the tire during rotation of the steering wheel (i.e., while a steering torque is generated), the driver worries about tire slippage and reduces the steering torque instead of generating the steering torque to a maximum value (refer to plot B of an actual steering torque of FIG. 4). Accordingly, the actual steering torque (i.e., pinion torque) input to a steering gear may be reduced, as shown in plot B of an actual steering torque, rather than being maintained as a maximum torque, as shown in plot A of an imaginary steering torque of FIG. 4. In addition, a torque corresponding to an area indicated by a slash pattern between the plot A of an imaginary steering torque and the plot B of an actual steering torque of FIG. 4 may be considered as the subtraction torque.

The compensation torque determination unit 30 may be configured to determine a compensation torque for compensating the actual steering torque based on the subtraction torque depending on vehicle speed. In other words, the compensation torque determination unit 30 may be configured to determine the compensation torque based on the subtraction torque and the real-time vehicle speed. To this end, the compensation torque determination unit 30 may include a gain determination map that is established to determine a gain of the subtraction torque depending on real-time vehicle speed. The compensation torque determination unit 30 may determine the gain of the subtraction torque using the gain determination map and may calculate the compensation torque according to “subtraction torque×gain”.

As shown in the graph of FIG. 5, the gain determination map may determine a gain of a subtraction torque. As shown in FIG. 5, the gain may be determined as a value that is not for compensating for the subtraction torque in a low-speed range less than a predetermined first vehicle speed “a”. The gain may be determined to increase with a predetermined ratio along with an increase in vehicle speed in an intermediate-speed range that is equal to or greater than the first vehicle speed “a” and less than the second vehicle speed “b”, and accordingly, a compensation value of the subtraction torque may also increase with a predetermined ratio. The gain may be determined to be maintained to a maximum value in a high-speed range equal to or greater than the predetermined second vehicle speed “b”. In other words, the subtraction torque may not be compensated for at low speed and may be compensated for with a maximum ratio (i.e., maximum gain) at high speed, and a compensation ratio may be increased depending on vehicle speed at an intermediate speed.

That is, when the vehicle speed is less than the predetermined first vehicle speed “a”, the gain may be determined as zero (‘0’), when the vehicle speed is equal to or greater than the second vehicle speed “b”, which is greater than the first vehicle speed “a”, the gain may be determined as a predetermined maximum gain “α”, and when the vehicle speed is equal to or greater than the first vehicle speed “a” and is less than the second vehicle speed “b”, the gain may be determined as a value between ‘0’ and the maximum gain “α” in proportion to vehicle speed. For example, the maximum gain “α” for determining the compensation value (i.e., compensation torque) of a subtraction torque may be 0.7 in the high-speed range, and the first vehicle speed “a”, the second vehicle speed “b”, and the maximum gain “α” may be adjusted and set depending on a vehicle. The first vehicle speed “a” may be determined as a value that is greater than 0 by a predetermined value and the second vehicle speed “b” may be determined as a value that is greater than the first vehicle speed “a” by a predetermined value.

The compensation torque determined by the compensation torque determination unit 30 may be generated by the electromotor 3, and may be transmitted to a side of the steering gear 4.

The motor torque determination unit 40 may be configured to subtract the compensation torque from a motor assist torque for assisting the driver steering torque to determine the output torque of the electromotor 3. In detail, the motor torque determination unit 40 may include a motor assist torque determination unit 41 and a motor output torque calculation unit 42.

The motor assist torque determination unit 41 may be configured to estimate and predict an assist torque (i.e., motor assist torque) of the electromotor 3, for assisting a driver steering torque, and may be configured to determine the motor assist torque based on a driver steering torque, a steering angle (i.e., driver steering angle) of the steering wheel 1, and real-time vehicle speed. To this end, the motor assist torque determination unit 41 may include a motor assist torque determination map for determining the motor assist torque based on the driver steering torque, a steering angle, and the real-time vehicle speed.

The motor output torque calculation unit 42 may determine the output torque (i.e., the motor output torque) of the electromotor 3 based on a motor assist torque predicted by the motor assist torque determination unit 41 and a compensation torque calculated by the compensation torque determination unit 30. In detail, the motor output torque calculation unit 42 may determine the motor output torque as a value calculated by subtracting the compensation torque from the motor assist torque.

The motor output torque determined by the motor torque determination unit 40 may be input to the steering gear 4 together with a driver steering torque that is generated in real time, and thus the actual steering torque at which the subtraction torque is compensated for (i.e., the actual steering torque compensated to be a value approximate to imaginary steering torque) by the compensation torque may be inputted to a pinion of the steering gear 4.

When an output torque of the electromotor 3 is determined and controlled using the above configured motor torque control device according to the present disclosure, the actual steering torque may be compensated by an approximate value to an imaginary steering torque using the compensation torque determined by the compensation torque determination unit 30 and, accordingly, this may appropriately compensate for the reduction in driver steering torque due to the reduction in the restoring moment. In other words, even if the driver increases the steering angle of the steering wheel and reduces the steering angle during vehicle turning (refer to B of FIG. 4), the reduction in driver steering torque (i.e., subtraction torque) may be compensated for by an electromotor and an approximate steering torque to the imaginary steering torque (which is a steering torque generated when the steering wheel is rotated at a maximum steering angle) may be transmitted to a side of the steering gear. Accordingly, a vehicle is capable of turning using the lateral force of a tire to a maximum degree, and the turning performance of the vehicle may be enhanced using tire performance to a maximum degree.

The motor torque control device of the vehicle steering system according to the present disclosure may control a motor torque (i.e., the output torque of an electromotor) to additionally generate a compensation torque for compensating the actual steering torque when an electromotor generates a motor assist torque for assisting a driver steering torque to enhance the turning performance of the vehicle using tire performance to a maximum degree during vehicle driving.

According to the present disclosure, because tire performance is used to a maximum degree, a driver's steering sense through a steering wheel may be enhanced during vehicle driving, and thus a stable steering sense may be provided to the driver.

The present disclosure has been described in detail with reference to exemplary forms thereof. However, it will be appreciated by those skilled in the art that changes may be made in these forms without departing from the principles and spirit of the present disclosure.

What is claimed is:

1. A motor torque control device of a vehicle steering system, comprising:
an imaginary steering torque determination unit configured to estimate an imaginary steering torque which is input to a steering gear of a vehicle when a steering wheel of the vehicle is rotated at a maximum steering angle;
a subtraction torque determination unit configured to calculate a difference between the imaginary steering torque and an actual steering torque which is determined based on a real-time steering angle of the steering wheel;
a compensation torque determination unit configured to determine a compensation torque for compensating the actual steering torque based on the difference and a vehicle speed of the vehicle; and
a motor torque determination unit configured to determine an output torque of an electromotor based on the compensation torque and a motor assist torque of the electromotor for assisting a driver steering torque.

2. The motor torque control device of claim 1, wherein the imaginary steering torque determination unit estimates the imaginary steering torque based on a lateral force of a tire of a vehicle wheel of the vehicle and an imaginary pneumatic trail, where the imaginary pneumatic trail is a pneumatic trail value at which tire slippage of the vehicle does not occur.

3. The motor torque control device of claim 2, wherein the imaginary steering torque is calculated as:
Imaginary steering torque=Lateral force of tire×(Caster trail+Imaginary pneumatic trail)/Moment arm×Steering gear ratio+Friction torque,
where:
the caster trail is a distance between an intersection point of a vertical line passing through a center of a wheel hub of a vehicle wheel at a road surface and an intersection point of a downward extension line of a central line of a kingpin at the road surface,
the moment arm is a distance between a kingpin and a tie road,
the steering gear ratio is a gear ratio between a pinion and a rack bar of the steering gear, and
the friction torque is a friction torque generated in the steering system.

4. The motor torque control device of claim 3, wherein the imaginary steering torque determination unit estimates the lateral force of the tire based on a lateral acceleration and a yaw rate of the vehicle, a real-time vehicle speed, a vehicle weight, a distance to the vehicle wheel from a vehicle center, and a mass moment of inertia.

5. The motor torque control device of claim 1, wherein the subtraction torque determination unit calculates a subtraction torque by subtracting the actual steering torque from the imaginary steering torque, and calculates the actual steering torque by summing the motor assist torque and the driver steering torque generated in real time.

6. The motor torque control device of claim 5, wherein the compensation torque determination unit determines a gain of the subtraction torque based on the vehicle speed and determines the compensation torque using the gain.

7. The motor torque control device of claim 6, wherein, when the vehicle speed is less than a predetermined first vehicle speed, the gain is determined as zero (“0”), when the vehicle speed is equal to or greater than a second vehicle speed that is greater than the first vehicle speed, the gain is determined as a predetermined maximum gain value, and when the vehicle speed is equal to or greater than the first vehicle speed and less than the second vehicle speed, the gain is determined as a value between 0 and the maximum gain in proportion to the vehicle speed.

8. The motor torque control device of claim 7, wherein the compensation torque is calculated as: Subtraction torque×Gain.

9. The motor torque control device of claim 1, wherein the motor torque determination unit determines the output torque of the electromotor as a value obtained by subtracting the compensation torque from the motor assist torque.

10. The motor torque control device of claim 9, wherein the motor torque determination unit includes a motor assist torque determination unit configured to determine the motor assist torque based on the driver steering torque, a steering angle, and the real-time vehicle speed of the vehicle.
